(19) United States
(12) Patent Application Publication
(10) Pub. No.: US 2022/0398321 A1
(43) Pub. Date: Dec. 15, 2022

(54) DATA MANAGEMENT

(71) Applicant: Hewlett-Packard Development Company, L.P., Spring, TX (US)

(72) Inventors: Adrian John Baldwin, Bristol (GB); Stuart Lees, Bristol (GB); Jonathan Griffin, Bristol (GB); Daniel Ellam, Bristol (GB)

(21) Appl. No.: 17/755,012

(22) PCT Filed: Nov. 22, 2019
(86) PCT No.: PCT/US2019/062760

§ 371 Date: Apr. 19, 2022

(51) Int. Cl. G06F 21/57; G06F 21/56

(52) U.S. Cl. CPC G06F 21/575; G06F 21/568

(57) ABSTRACT

In some examples, a method for data management, the method comprises booting a trusted diskless operating system image via a device firmware component, accessing a non-volatile storage of the device using the trusted diskless operating system image; and retrieving user data from the non-volatile storage of the device, and/or writing user data received from a remote location to the non-volatile storage of the device.

### BACKGROUND

A user device can become inoperable or compromised for a number of reasons. For example, a device operating system that is provided on a local storage of the device may become corrupted due to general filesystem or upgrade issues, or may become infected by malware.

### BRIEF DESCRIPTION OF THE DRAWINGS

Various features and advantages of certain examples will be apparent from the detailed description which follows, taken in conjunction with the accompanying drawings, which together illustrate, by way of example only, a number of features, and wherein:

FIG. 1 is a schematic representation of a method for data management according to an example;

FIG. 2 is a schematic representation of a user data modification process according to an example; and

FIG. 3 is a schematic representation of a device according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

An endpoint device, such as a user device in the form of a computer, laptop or other computing or smart apparatus for example, may be able to use a variety of different operating systems. In general, such operating systems are provided on a local storage location of the device in question.

Operating systems are continually under attack from various actors wishing to find an exploit that lets them run their own software or malware, such as but not limited to, remote access trojans, ransomware or cryptocurrency miners. There also can be other issues, software or hardware, that render the endpoint device compromised, unbootable or unusable.

Once the endpoint device finds itself in such a state there can be a degree of data loss to the system/user. For example, user data loss may occur as a result of ransomware encrypting user data files, general filesystem issues on the storage device, failed Operating system or software upgrade, and the user not having stored their data within a location that is backed up or synced to a backup service, such as a cloud service for example.

A reimaging operation, which is a process in which all software on a device is removed and subsequently reinstalled, is often seen as a good way to solve issues such as when a system is running slowly, not working properly or compromised, or when infected by malware for example. However, when reimaging occurs it can lead to data loss, particularly where data is not backed up using a data backup and recovery mechanism, such as a backup agent or by syncing to remote storage. Such mechanisms rely on the user to have stored information within the right locations or to have actually enabled a backup service in the first place. Furthermore, in some instances, the user data may be the root cause of the issue that prompted a reimaging operation, so even if backed up, it may re-compromise the reimage system by virtue of its subsequent reintroduction.

According to an example, there is provided a method to enable a user of a device, or the device itself, to launch a secured augmented trusted diskless operating system image to enable the uploading of data, such as user data, (in its entirety, or selectively) from a storage location of the device to a secure location that is remote from the storage location and hence the device. The storage location of the device can include a hard disk drive, tape drive, floppy disk, optical disc, or USB flash drive and so on.

In an example, the trusted diskless operating system image can be launched via the BIOS of the device. The device can then be reimaged, and once reimaged user data can be returned to the storage location of the device. In an example, data returned to the storage location of the device can be provided in a modified or sanitised form.

In an example, data from the storage location of the device can be in the form of a complete or partial image of the operating system of the device, or a complete or partial image of the contents and structure of a storage volume or of an entire data storage location of the device. Such an image, uploaded to the remote secure location, can be used by an enterprise or security agent in a forensic manner where the disk image can be, for example, analysed, certified and examined. In an example, such an uploaded image can be mounted in an execution environment such as a virtual machine to enable the enterprise etc. to examine the live image in a sandbox environment, look at its behaviours and recover any lost data or applications. Moving the image into the cloud also provides the option for a user to use it as a thin client as part of a recovery process.

Thus, according to an example, a trusted diskless OS (operating system) image can be booted from a device to enable data to be moved to/from the device without recourse to the device's OS, which can be useful if the OS is corrupt or compromised. This can be used to ensure that any data that is not backed up on the device is saved before, for example, the device is reimaged. It can also provide a centralized way to provide user updates.

It is therefore possible to keep user data provided in local storage location of a device in the event of an operating system failure or in the event of a platform recovery and reimage event. The device can securely boot the trusted diskless image specified within the BIOS that will allow the upload of user data to a safe location remote form the device prior to, for example, reimaging the device and hence destroying user data. This provides a back-up mechanism even if the OS is corrupted and not booting or not in a trusted state due to a security issue.

User data can be returned to the storage location of the device as part of a reimaging process, or post a reimaging process from within the securely booted trusted image whilst being able to maintain the encrypted status of the storage device. In an example, user data can comprise user documents stored on the storage location of the device disk or user documents found in non-synced locations, an entire or partial filesystem structure, lower level structures, such as disk blocks, allowing deeper forensic analysis (including deleted files), and deduplication blocks, for example changes from a standard disk image that may be maintained the enterprise maintains.

According to an example, a trusted diskless boot image used for reimaging or storage management can be specified within the device BIOS. For example, a location of such an image can be specified in the BIOS. Alternatively, the BIOS can offer the ability to execute a secure agent that can be configured to download or mount the trusted diskless boot image from a specified location, which can be remote from the device. In an example, the BIOS, secure agent, or a secure enclave of the device, such as a trusted platform module for example, can store data representing one or more of the location of the trusted diskless boot image, a public key used to sign the trusted diskless boot image, and a hash of the trusted diskless boot image. The BIOS, for example, can compare the hash of the trusted diskless boot image with a hash of a trusted diskless boot image retrieved from a remote location in order to validate any downloaded/mounted image.

In an example, the device user or an enterprise may trigger a boot or mount of an OS of the trusted diskless boot image. A user may trigger an action at a reboot via the bios menus (e.g. after pressing f10), or an Enterprise or the user may trigger the boot via a management app with a client on the local device or via a local device app which would send a command to the BIOS via WMI call. This command would be protected in the way that BIOS settings are protected on the device; for example, requiring a BIOS Admin Password or signed with a BIOS management private key.

For example, upon receipt of a Windows Management Instrumentation (WMI) call, or similar for other systems, the device BIOS can be configured to force the device to change operational or power state, e.g. to hibernate or reboot through an ACPI power management interface. The BIOS can be configured to then trigger boot of the trusted diskless boot image, which can be provided at a remote location from the device, using one of the mechanisms described above for example. A public key can be provided for the remote location so that the system can securely communicate with it. Once booted, the OS of the trusted diskless boot image can be used to securely move user data from a storage location of the device to a remote data storage location, e.g. a cloud-based storage location accessible by the OS of the trusted diskless boot image. In an example, this is a trusted process since the BIOS code is below the OS and well protected and validated prior to running. This would make it very hard for any attacker to subvert this process and hence the data management agent. Once the user data is moved, the device may be reimaged for example.

The upload of user data to a secured location gives the user/enterprise a large degree of choice as to what they can then do with the data. For example, in the case that the user data corresponds to the contents and structure of a storage volume or of an entire data storage location of the device forming a disk image of a storage location of the device, an enterprise, knowing the data was retrieved using a trusted secure OS, can mount the disk image in a virtual machine and run forensic analysis suites upon it, which can enable it to clean the data of any malware or unauthorised software before being making the data available to a user. The (clean or otherwise) data can be made available to the user via another interface, allowing them to retrieve their files. In another example, the enterprise can construct an image for the device, optionally containing the user's data, for the purpose of returning it to the storage of the endpoint device. The constructed image can include sanitized data and/or additional data in the form of patches or additional applications and so on.

In an example, an enterprise can return just changed or altered data blocks to the device using deduplication to save time and storage requirements. For example, uploaded user data can be processed in order to clean the data of any malware or unauthorised software and/or augment or replace data or applications in the user data. The use of deduplication data reduces the data that needs to be uploaded. For example, a list of OS and common application files in the cloud can be download to the agent and the agent can send back hashes of files that are known rather than the full file. An alternative example would be for the agent to send hashes of the (larger files) on the system and then the cloud side to mark which are known such that unknown files are returned. Equally common files (or even partial files could be identified) to reduce upload back to the cloud.

According to an example, when booted, a trusted diskless boot image can execute a script which connects to the main OS drive of the device in order to enable e.g. an enterprise specified (or user chosen) data backup script to be executed, which can perform one or more of the afore-mentioned backup options. In an example, such a script can be integrated into a recovery agent provided as part of the OS or BIOS so that prior to reimaging there is the opportunity to capture data that the user has failed to backup or a complete image that can be run in the cloud as described above. In another example, a trusted diskless agent can examine the on-device storage to find data that is not covered by normal backup services or cloud-based disk synchronization processes. This mechanism would find data likely to be lost to the user on a reimage. This data can then be backed up to the remote device.

In an example, when an endpoint device is securely booted using a trusted diskless boot image providing a trusted augmented operating system, data can be written to a storage location of the device using an encryption key retrieved earlier for reading data from the storage location (as described in more detail below), thereby maintaining security of the user's and enterprise data. For example, a standard endpoint image can be written to the storage location. Alternatively, a standard endpoint image plus user data can be written to storage location. Various other alternatives are possible. For example, a repaired endpoint image can be written to storage location, or a custom image can be written to storage location, for example, containing extra forensic analysis software not currently present in a standard image, or an updated image (for example OS upgrade) can be written to storage location, optionally with user data, or (as mentioned above) only changed blocks, when compared with a standard image, can be written to storage location.

According to an example, from a security perspective, if a device identity can be accessed within a trusted platform module hierarchy, such as one based on an identity within the trusted platform module for example, this can be used to identify the device whose disk image or data is going to be uploaded prior to e.g. reimaging. This can be used to certify an ephemeral public, private key pair that can be passed to a recovery agent and used to secure communications with a backup server for example. As the location of the storage is also stored securely in the BIOS the public key of the storage service can also be provided which allows the generation of keys for the storage session.

In an alternative example, a code, such as a QR code for example, containing a random nonce could be generated by a recovery agent that a user can scan with a smart device. The QR code can encode data that, when scanned and processed using the smart device, can lead the user to a website for example where they can log in (for example using an enterprise single sign on). In another example, the code could include an encryption key that could be used to recover the data on the cloud or on attempting to reload data back onto the device. This can therefore provide a storage service that does not have access to the data without user intervention. An area for the backup/uploaded user data to be placed can be created using the nonce as a name. The data to be backed up can be encrypted using a symmetric key which is encrypted using a public key configured into the BIOS. The public key would belong to the user or the enterprise allowing the data to be decrypted at the storage service. Use of a QR code, or similar, provides a convenient option for a user. The BIOS can have a public key of the cloud service doing the storage to securely deliver the data to the right place, and the QR code can include information relating to the download (e.g. a device serial number or a nonce) which would enable the user to identify their data.

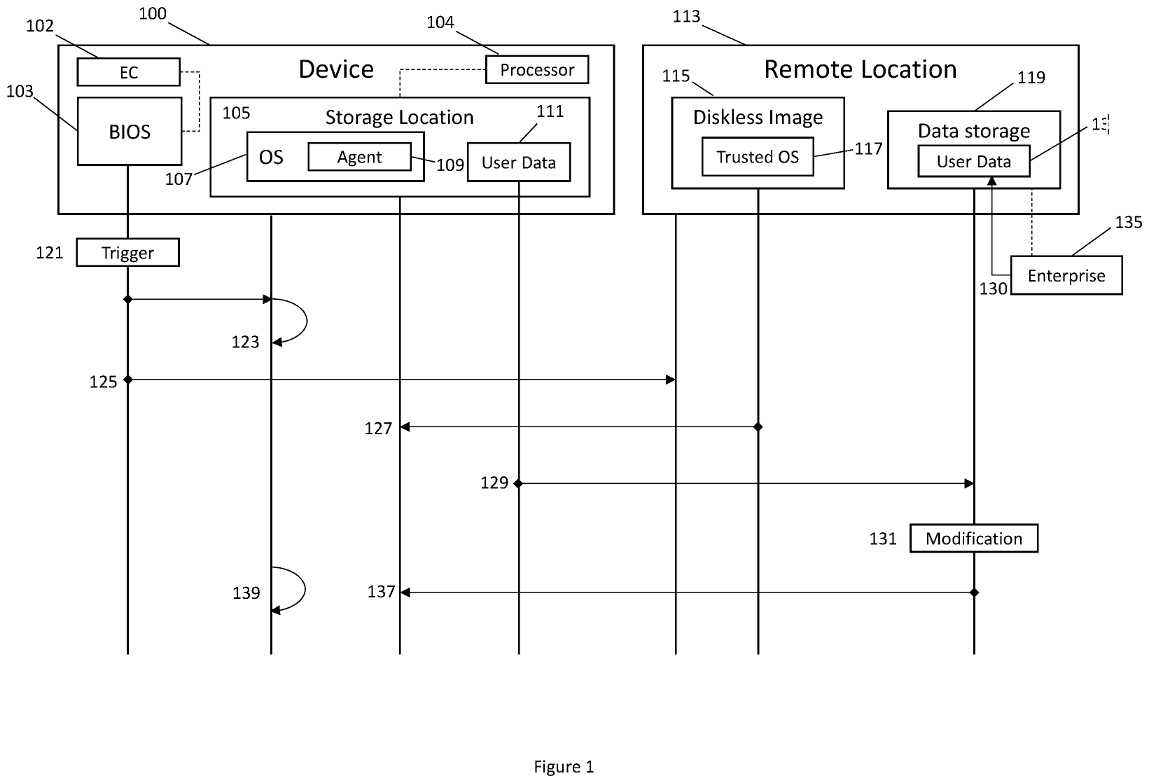

FIG. 1 is a schematic representation of a method for data management according to an example. A device 100 comprises a BIOS 103 and a storage location 105 (which can comprise e.g. disc or flash-based storage, CD-ROM, optical storage, etc.). The storage location 105 stores a device OS 107, which may include a security agent 109, and user data 111. A remote (from device 100) location 113 comprises a trusted diskless boot image 115. In an example, the trusted diskless boot image 115 includes a trusted augmented operating system 117. Remote location 113 includes a data storage apparatus 119. In some examples, data storage apparatus 119 can be provided in an alternative location that is itself remote from location 113. Alternatively, data storage apparatus 119 can be provided at location 113, whilst OS 117 may be provided in an alternative location that is itself remote from location 113.

According to an example, a trigger event (or message) 121 is received by BIOS 103. The trigger 121 may be generated by agent 109 either by way user input (e.g. device user, or a third party such as an enterprise security controller), or directly by a user via the OS 107 (e.g. the device user, or a third party such as an enterprise management system). Upon receipt of the trigger 121, BIOS 103 activates a change in the operational state of device 100 by causing a reboot 123 for example.

Following the change of state, BIOS 103 can send a request 125 to remote location 113 for the trusted diskless boot image 115. BIOS 103 can, in an example, receive the location of the location 113 from an additional security controller 102, which can be a trusted component, for example or additional security module that has security functions and secure (integrity checked) storage and hence provides a suitable place for storing information whose integrity is security sensitive. The trusted OS 117 executing by way of the trusted diskless boot image 115 can access 127 the storage location 105 of device 100. In an example, the diskless image is delivered from 113 but executes within 100 (i.e. using processor 104). For example, as part of request 125, BIOS 103 can provide an access key for use by the trusted OS 117 to enable it to access the storage location 105. In an example, the key may be received from a remote location. The trusted OS 117 retrieves 129 user data 111 from storage location 105 and uploads it data storage 119.

The user data stored in the data storage 119 (133) can be subject to modification 131. For example, as described above, an enterprise 135 can clean the data 133 by removing malware or other data or applications, augment it by patching or adding applications and so on. Once modified, the data 133 can be returned 137 to device 100 from data storage 119. This can occur before, after or during (e.g. as part of) a reimaging process 139 of the storage location 105 of device 100.

As described above, user data 133 can comprise the contents and structure of a storage volume such as part (e.g. a partition) of the storage location 105, or of an entire data storage location 105 of the device 100 thereby forming a disk image of a storage location of the device. As such, enterprise 135 (or an enterprise approved service) can mount 130 the data 133 to perform modification 131. In an example, modified or unmodified data can be uploaded to the cloud or rewritten to the device.

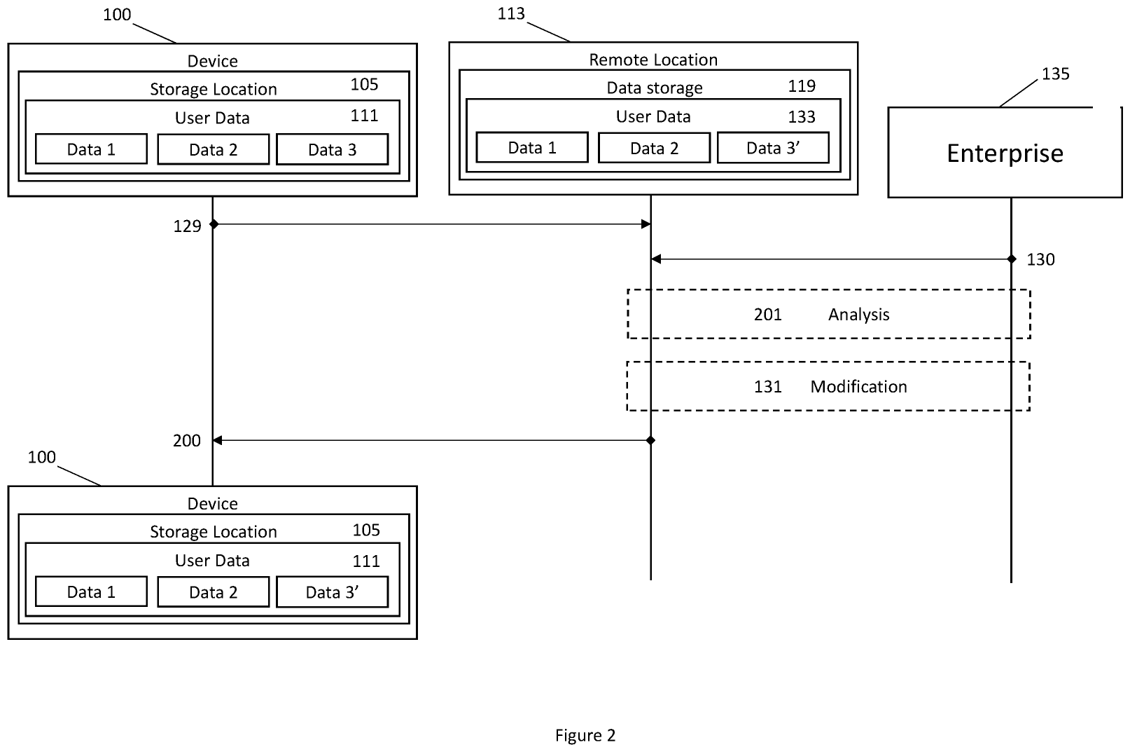

FIG. 2 is a schematic representation of a user data modification process according to an example. As described with reference to FIG. 1, user data 111 is uploaded to data storage 119 at a remote location 113. In the example of FIG. 2, user data 111 comprises three portions of data: Data 1, Data 2, and Data 3. With reference to FIG. 2, a portion of data may comprise user data forming a data block, an application, malware, a document, or a more general portion of data such as data representing a registry entry for example.

As noted with reference to FIG. 1, enterprise 135 can access 130 the user data stored in the data storage 133 and modify it (131). In the example of FIG. 2, user data 133 is modified 131 by the enterprise 135 such that data portion Data 3 becomes data portion Data 3′. This modified data portion can be returned 200 to device 100, either in combination with other data portions or in isolation (since it was the only data portion modified). In the latter case, the modified data portion (Data 3′) can overwrite an unmodified data portion (Data 3) in storage location 105 of device 100. In effect, this provides a mechanism to reimage device 100 using only those data portions that have been modified, thereby saving time and bandwidth.

Modified data portion Data 3′ can represent a sanitised, patched, or alternative version of data portion Data 3. For example, once accessed (130), enterprise 135 can analyse 201 the user data 133. As noted above, this can be to determine whether malware is present for example, and/or to remove, augment, or update an e.g. application for the device 100.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus (for example, agent 109) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

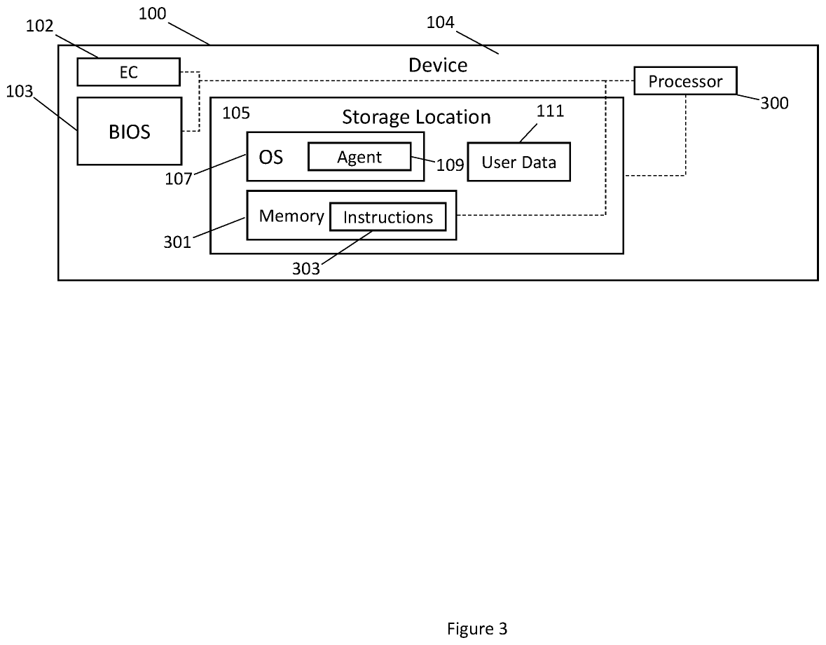

FIG. 3 is a schematic representation of a device according to an example. Device 100 comprises a processor 300 associated with a memory 301. The memory 301 comprises computer readable instructions 303 which are executable by the processor 300. The instructions 303 can comprise instructions to: boot a trusted diskless operating system image 115 via a device firmware component 103 (e.g. in response to a trigger 121), access a non-volatile storage 105 of the device 100 using the trusted diskless operating system image 115, and retrieve 129 and/or write 137 data from (111) or to (133) the non-volatile storage 105 of the device 100. In an example, instructions 303 can be executed by processor in response to an instruction from BIOS 103. In another example, instructions 303 can be executed by BIOS 103.

Such machine readable instructions 303 may also be loaded onto a computer or other programmable data processing devices, so that the computer or other programmable data processing devices perform a series of operations to produce computer-implemented processing, thus the instructions executed on the computer or other programmable devices provide a operation for realizing functions specified by flow(s) in the flow charts and/or block(s) in FIGS. 1 and 2.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method for data management, the method comprising:
booting a trusted diskless operating system image via a device firmware component;
accessing a non-volatile storage of the device using the trusted diskless operating system image;
retrieving user data from the non-volatile storage of the device, and/or writing user data received from a remote location to the non-volatile storage of the device.

2. The method as claimed in claim 1, further comprising:
mounting user data retrieved from the non-volatile storage of the device; and
analysing the said retrieved user data.

3. The method as claimed in claim 2, further comprising:
mounting the user data retrieved from the non-volatile storage of the device in an execution environment.

4. The method as claimed in claim 1, further comprising:
cleaning user data retrieved from the non-volatile storage of the device.

5. The method as claimed in claim 1, further comprising:
checking whether any parts of the user data to be retrieved are present in the remote store, whereby to reduce the amount of user data to be retrieved.

6. The method as claimed in claim 1, further comprising:
modifying user data retrieved from the non-volatile storage of the device to form modified user data. The method as claimed in claim 6, further comprising:
returning the modified user data to the non-volatile storage of the device.

8. A device, comprising:
a storage location including user data; and
a BIOS to:
receive a trigger to initiate retrieval of a trusted diskless boot image from a remote location; and
provide a security key to enable access to the storage location of the device by the trusted diskless boot image.

9. The device as claimed in claim 8, the BIOS further to, in response to the trigger, initiate a change in state of the device.

10. The device as claimed in claim 8, the BIOS further to retrieve the security key from a security controller of the device.

11. The device as claimed in claim 8, the BIOS further to retrieve the trusted diskless boot image from the remote location in response to the trigger.

12. The device as claimed in claim 8, the BIOS further to execute a secure agent to download the trusted diskless boot image from the remote location.

13. The device as claimed in claim 8, the BIOS further to compare a hash of an expected trusted diskless boot image with a hash of the trusted diskless boot image retrieved from the remote location.

14. A machine-readable storage medium encoded with instructions for data management, the instructions executable by a processor of an apparatus to cause the apparatus to:
change an operational state to reboot the apparatus;
provide a security key to enable access to a storage location of the apparatus; and
retrieve modified user data from a data storage apparatus of a remote location.

15. The machine-readable storage medium as claimed in claim 14, further comprising instructions to:
execute a recovery process using an image stored in the data storage apparatus of the remote location.
